(19) United States
(12) Patent Application Publication
(10) Pub. No.: US 2012/0062605 A1
(43) Pub. Date: Mar. 15, 2012

(54) LED BACKLIGHT DIMMING CONTROL FOR LCD APPLICATIONS

(76) Inventor: OVIDIU AIOANEI, San Jose, CA (US)

(21) Appl. No.: 12/878,767

(22) Filed: Sep. 9, 2010

(51) Int. Cl. G09G 5/10; G09G 3/36

(52) U.S. Cl. 345/690; 345/102

(57) ABSTRACT

According to embodiments disclosed herein, a liquid crystal display (LCD) panel system may include a display system, and a timing controller and power management circuit to provide control signals and power to the display system, wherein the control signals include an adjustable current to control the LCD panel brightness. Further according to some embodiments disclosed herein, a method for controlling the brightness of an LCD panel system having a display system may include the steps of using a timing controller and power management circuit to provide control signals and power to the display system; the control signals including an adjustable current to control the LCD panel brightness.

### BACKGROUND

1. Field of the Invention

The embodiments described herein relate generally to the field of power management and, more particularly, to systems and methods for integration of power management with timing controllers for Liquid Crystal Display (LCD) applications.

2. Description of Related Art

In current LCD panel systems, the interaction between the timing controller (TCON) and the power management integrated circuit (PMIC) is generally limited to an enable signal and a pulse-width modulation (PWM) signal for light-emitting diode (LED) backlight dimming control. Thus, backlight dimming control is achieved by utilizing the enable function of the LED driver and turning ‘on’ and ‘off’ the LED current sources with a specific frequency and duty cycle, using a PWM signal. The duty cycle is defined as the portion of time in a given ‘on/off’ sequence in the LED driving pulse during which the LED is actually ‘on’. For example, by reducing the duty cycle of the signal, the average LED current is reduced and so is the overall brightness of the LCD backlight, with the result of ‘dimming’ the LCD display. The opposite effect may be achieved by increasing the duty cycle of the signal provided to the LED driver. Furthermore, a ‘dimming’ effect may also be obtained in current LCD displays by adjusting the frequency of the signal provided to the LED driver. Reducing the duty cycle of the signal may lower the average current provided to a display. Thus again, it is the average LED current provided that ultimately controls the relative brightness of the display.

However, the above described schemes for ‘dimming’ the brightness of an LCD panel system are not power efficient because the peak current provided to the LED driver is always the same. The need for a fast turning ‘on’ and ‘off’ of the device may use a sudden release and stop of energy flow, which usually is accompanied by excessive energy loss. Furthermore, the sole use of PWM schemes for LCD dimming may result in a minimum LCD brightness that may not be zero, with the consequent expense in power, and lack of image control. By the same token, a maximum brightness is also fixed, as given by the amount of current provided to the LED driver under a 100% duty cycle. This may unnecessarily limit the capabilities of an LCD display. For example, a situation may arise whereby the transmission efficiency of the LCD panel is reduced due to stress and usage of the liquid crystal. Under these circumstances a higher peak brightness of the backlight LEDs may be desired.

What is needed is a system and a method to provide regulation of the brightness of an LCD display that is energy efficient, is integrated to the PMIC, and provides more capabilities to the PMIC.

### SUMMARY

According to embodiments disclosed herein, a liquid crystal display (LCD) panel system may include a display system, and a timing controller and power management circuit to provide control signals and power to the display system, wherein the control signals include an adjustable current to control the LCD panel brightness.

Further according to some embodiments disclosed herein, a method for controlling the brightness of an LCD panel system having a display system may include the steps of using a timing controller and power management circuit to provide control signals and power to the display system, the control signals including an adjustable current to control the LCD panel brightness.

These and other embodiments of the present invention are further described below with reference to the following figures.

### BRIEF DESCRIPTION OF THE DRAWINGS

FIG. 1 illustrates a block diagram of an LCD panel system according to some embodiments.

FIG. 2 illustrates a block diagram of an LCD panel system consistent with some embodiments of the present invention.

FIG. 3 shows an LCD display according to some embodiments of the present invention.

FIG. 4 illustrates an LCD panel system including a timing controller and power management circuit, an LED driver, and an LED array according to some embodiments of the present invention.

FIG. 5 shows an LCD panel using three co-located LED arrays, according to some embodiments of the present invention.

In the figures, elements having the same designation have the same or similar functions.

### DETAILED DESCRIPTION

The use of liquid-crystal display panels has increased at a fast pace in the last decade. The panels' size may extend from only a couple of inches for simple information displays to tens of inches for HDTV standards. The multimedia phenomenon has become part of consumer's daily life creating a need for innovative displays able to deliver content to various market segments. Optimizing power consumption has been a long-standing consideration in the design of electronic products. Therefore, managing the power consumption in display panels is highly desired for achieving more battery life and less use of energy.

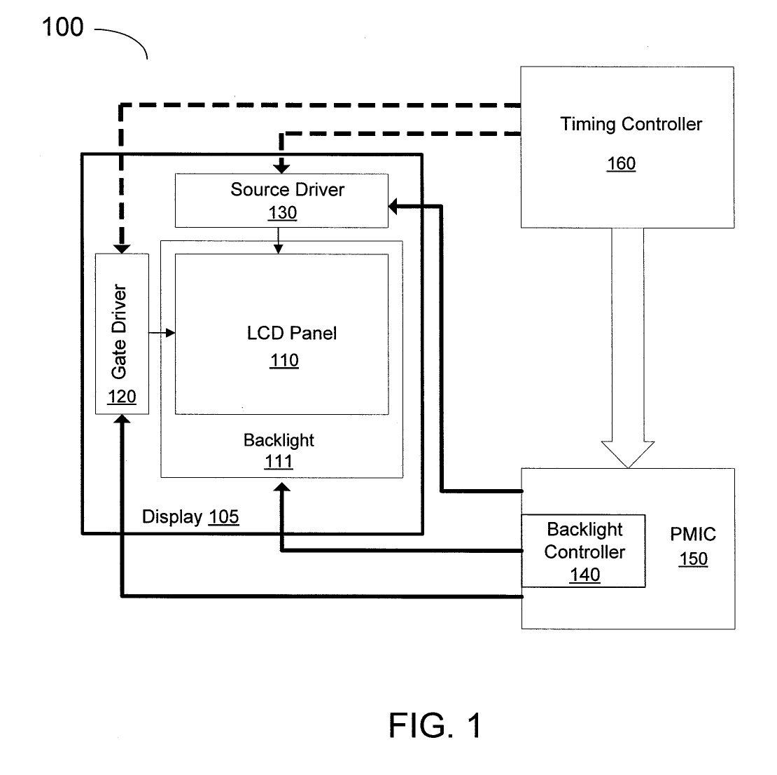

FIG. 1 illustrates a block diagram of LCD panel system 100. System 100 may include display system 105, timing controller 160, and power management unit 150. According to some embodiments, display system 105 may further include LCD panel 110, gate driver 120, source driver 130, and backlight unit 111. In some embodiments, backlight 111 provides the illumination used to display an image by LCD panel 110. According to some embodiments of system 100, power management unit 150 may be an integrated circuit (PMIC), including backlight controller unit 140, which may provide a control signal and power to backlight 111. Further, in some embodiments PMIC 150 and timing controller 160 may be included as discrete entities. Timing controller 160 may provide a PWM signal to PMIC unit 150 in order to adjust the brightness of the backlight in LCD panel 110, through backlight controller 140.

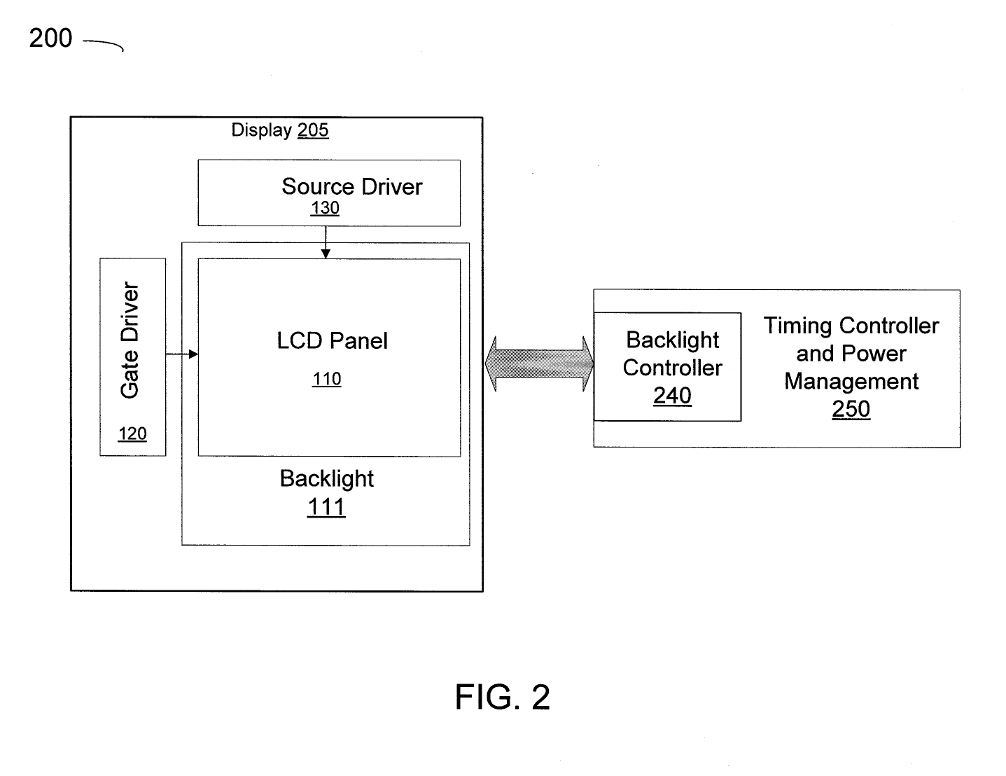

FIG. 2 illustrates a block diagram of LCD panel system 200 consistent with some embodiments of the present invention. System 200 may include timing controller and power management unit 250 and display system 205. According to some embodiments of the present invention, display 205 may further include LCD panel 110, gate driver 120, source driver 130, and backlight unit 111. LCD panel 110, gate driver 120, source driver 130, and backlight unit 111 are controlled by timing controller and power management unit 250. Unit 250 may also provide power supplies to all elements included in display 205, including: panel 110, driver 120, driver 130, and backlight unit 111. In some embodiments of the present invention, backlight layer 111 may be placed on the back of panel 110. Backlight unit 111 may provide light rays that travel through panel 110, creating the image displayed by system 200. Backlight 111 may be controlled by unit 240 in block 250, according to some embodiments of the present invention. In some embodiments, LCD panel 110 may also include a liquid crystal layer adjacent to backlight 111. The liquid crystal layer may regulate the brightness of the light rays that travel through panel 110 (not shown in FIG. 2).

Unit 250 may include timing controller functions, as in unit 160, and power management functions, as in PMIC 150 (cf. FIG. 1). As depicted in the embodiment of FIG. 2, unit 250 may adjust the amplitude of a current provided to display 205 to control the brightness of LCD panel 110. In some embodiments of the present invention, unit 250 may also provide a PWM signal to adjust a duty cycle and frequency of the power provided to display 205. Timing controller functions may be combined with power management functions in block 250, thus improving the performance of LCD panel system 200. For example, by adjusting the power for backlight unit 111 in controller 240, block 250 may reduce the brightness of a portion of LCD panel 110 to zero. Also, by combining a PWM and an adjustable power to backlight unit 111 in controller 240 a greater resolution in brightness variation of LCD panel 110 may be obtained. Some methods and systems for combining PWM and a variable power to an LED driver in a display 205 may be such as described in attorney docket item 70107.278, which is a patent application entitled “Dynamic Voltage Supply for LCD Timing Controller” by Ovidiu Aioanei and assigned to Integrated Device Technology, Inc. the assignee of the present invention, and filed on Sep. 8, 2010. Docket item 70107.278 is incorporated herein by reference in its entirety.

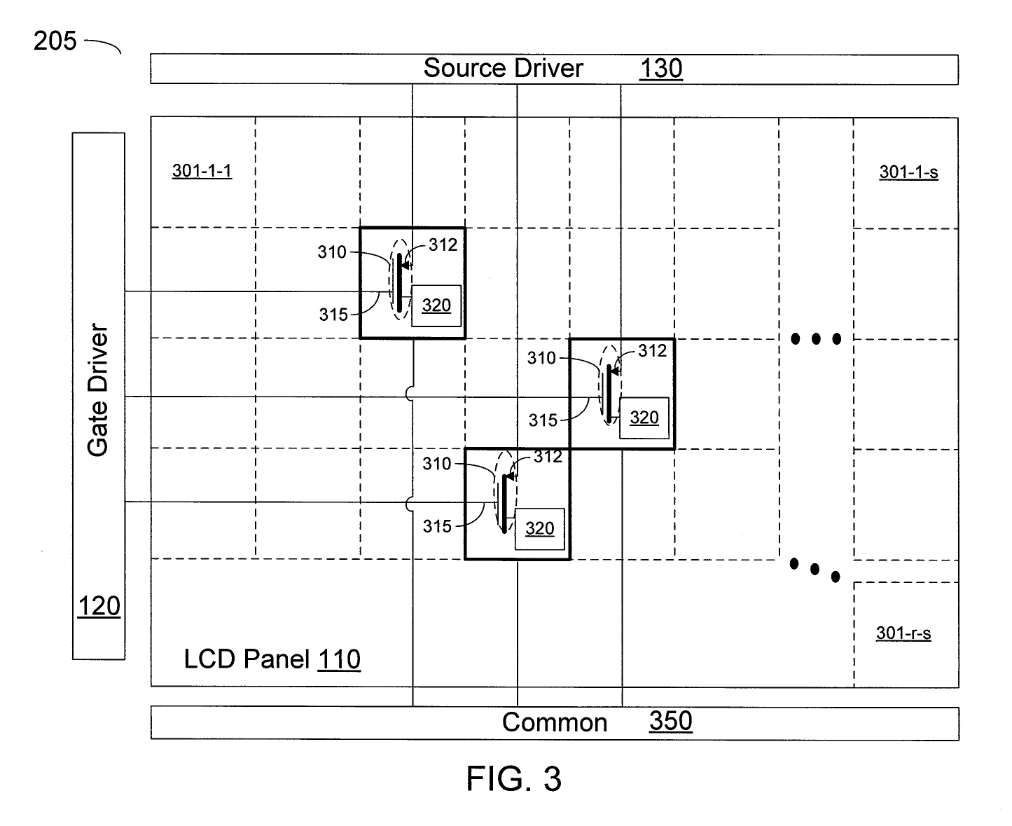

FIG. 3 shows LCD display 205 according to some embodiments of the present invention, including LCD panel 110, gate driver 120, source driver 130, and a common connector 350. Backlight unit 111 (cf. FIG. 2) is not depicted in FIG. 3 for clarity. According to some embodiment depicted in FIG. 3, panel 110 may include a two-dimensional array of pixels 301 having dimension ‘r×s’, where ‘r’ (rows), and ‘s’ (columns) may be any integer number. Each of pixels 301-1-1 to 301-r-s may include at least one transistor 310. In the embodiment depicted in FIG. 3, transistor 310 may be a P-channel MOSFET. Some embodiments of the present invention may use a different type of transistor, such as N-channel MOSFETs, or a bipolar transistor, or a combination thereof. Gate driver 120 may be coupled to provide a voltage to gate terminal 315 of transistor 310 associated with pixels 301 in LCD panel 110, according to some embodiments of the present invention. Likewise, source driver 130 may be coupled to provide a voltage for source terminal 312 of transistor 310 associated with pixels 301 in LCD panel 110, according to some embodiments of the present invention. In some embodiments of the present invention, all transistors 310 associated with pixels 301 in LCD panel 110 may have drain terminals coupled to pixel electrode 320. Furthermore, in some embodiments such as illustrated in FIG. 3, each pixel 310 may also include a common electrode (not shown in FIG. 3 for simplicity) coupled to common connector 350. According to some embodiments of the present invention, transistors 310 associated to pixel 301 in LCD panel 110 may regulate the amount of light going through the pixel by adjusting the voltage difference between pixel electrode 320 and the common electrode. In some embodiments the voltage difference may alter the transmissivity through a liquid crystal layer included in LCD panel 110 between pixel electrode 320 and common electrode. Thus, transistor 310 may control the brightness, color, polarization, and other characteristics of the light going through a given pixel 301 in LCD panel 110.

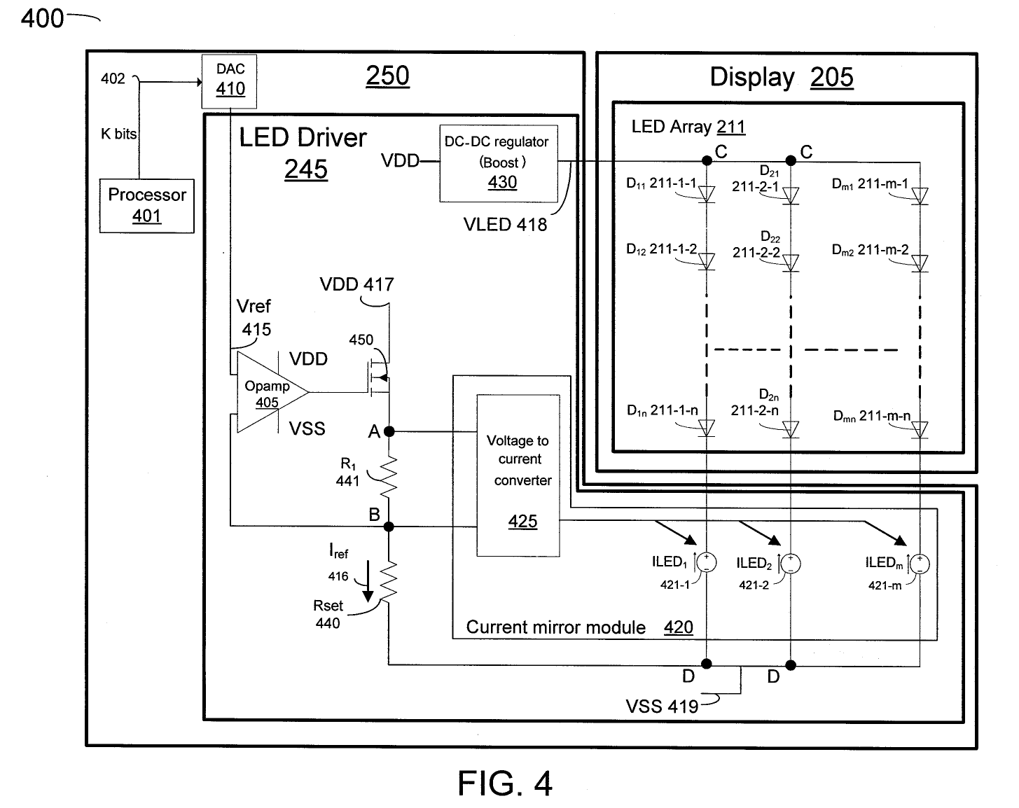

FIG. 4 illustrates LCD panel system 400 including timing controller and power management circuit 250, LED driver 245, and LED array 211, according to some embodiments of the present invention. In system 400, an embodiment of backlight 111 may include LED array 211, as illustrated in FIG. 4. LED array 211 may include an ‘m×n’ array of LEDs 211-1-1 to 211-m-n placed in the back of panel 110 to provide illumination for system 200, where ‘m’ and ‘n’ may be any pair of integer numbers. For example, in some embodiments of the present invention ‘m’ and ‘n’ may be the number of columns (‘m’) and the number of rows (‘n’) of pixels included in LCD panel 110. LCD panel 110 may further include a pixilated liquid crystal layer (not shown) that is positioned over LED array 211 to adjust the amount of light that may go through the pixels in LCD panel 110, thus forming an image having a preselected brightness.

According to FIG. 4, an embodiment of backlight controller 240 may include LED driver 245, to control LED array 211. According to the embodiment depicted in FIG. 4, unit 250 may further include processor unit 401, and digital-to-analog converter (DAC) 410. Furthermore, LED driver 245 may include operational amplifier 405, transistor 450, resistors 441 (R₁) and 440 (Rₛₑₜ), DC regulator 430, and current mirror module 420. In some embodiments of the present invention mirror module 420 may include voltage to current converter 425, and current mirrors 421-1 to 421-m.

In some embodiments dimming control for LED array 211 is achieved by utilizing the enable function of LED driver 245. By turning ‘on’ and ‘off’ LED current sources 421 with a specific frequency and duty cycle (Pulse Width Modulation) the average LED current is controlled. Thus, the overall brightness of the LCD backlight may be adjusted.

In some embodiments of the present invention a method to control brightness in LED array 211 may include adjusting the reference current for LED driver 245 based on an LED dimming algorithm executed by processor unit 401 in controller 250. Processor 401 may provide digital string 402 containing K number of bits, rather than a PWM (Pulse Width Modulation) signal, where ‘K.’ may be any integer. In some embodiments of the present invention the specific value of K may be determined by controller 250, according to the resolution of DAC 410. DAC 410 uses bit string 402 to generate reference voltage 415 (V_{ref}), thus adjusting reference current 416 (I_{ref}) using amplifier 405. According to the embodiments illustrated in FIG. 4, amplifier 405 may set the voltage of node B at V_{ref} 415. Thus, Rₛₑₜ 440 may provide current I_{ref} 416 according to Ohm's law: I_{ref}=(V_{ref}−VSS)/Rₛₑₜ. Some embodiments of the present invention may further include transistor 450 coupled to the output of amplifier 405. Transistor 450 may thus function as a current source to provide I_{ref} 416. In doing so, transistor 450 may also provide a voltage drop across nodes A and B (cf. FIG. 4) through resistor 341 (R₁). The voltage drop across R₁ 441 feeds voltage to current converter 425, which may be included in mirror module 420. Converter 425 may thus provide the current supply for module 420 to draw LED currents 421-1 to 421-m.

Further according to some embodiments of the present invention illustrated in FIG. 4, LED driver 245 may be supplied with a voltage 417 (VDD) and a voltage 419 (VSS). For example, VDD 417 may be provided to DC regulator 430, to amplifier 405, and to the drain terminal of transistor 450, according to some embodiments of the present invention. In some embodiments, VSS 419 may be supplied to amplifier 405, and to current mirror module 420 (node D). In some embodiments of the present invention, VDD 417 may be a positive voltage and VSS 419 may be a negative voltage.

I_{ref} 416 is provided to current mirror module 420, which in turn may provide LED currents 421-1 (ILED1) to 421-m (ILEDm), according to some embodiments of the present invention. LED current 421-j, where ‘j’ may be any integer between 1 and ‘m’, may be proportional to I_{ref} 416, according to the following expression:

I_{LED}_{ⱼ}=I_{Ref}×βⱼ (1)

Where ‘βⱼ’ is a factor that may be adjusted according to internal parameters in mirror module 420. For example, factor ‘βⱼ’ may be adjusted by changing internal resistor values and amplifier input voltages in converter 425. Thus, controlling reference current 416 adjusts the brightness of the LED in controller 240. In some embodiments of the present invention, the values of ‘βⱼ’ may be the same for all ‘j’ from 1 to ‘m’. In some embodiments, module 320 may provide different values of ‘βⱼ’, depending on the value of T. According to the embodiment shown in FIG. 4, the number of LED currents provided by module 420 may be equal to the number of columns ‘m’ in LED array 111. In some embodiments of the present invention, module 420 may provide a different number of LED currents, depending on the wiring of LEDs 211-1-1 to 211-m-n in array 211. For example, LEDs 211-1-1 to 211-m-n may be arranged such that each row ‘i’ of LEDs 211-1-i to 211-m-i shares the same LED current, where ‘i’ may be any integer value between 1 and ‘n’. In such a case, module 420 may provide a number ‘n’ of LED currents 421-1 to 421-n, assigned to each row of LEDs in array 211.

In the embodiment depicted in FIG. 4, LED driver 245 may provide voltage 418 (VLED) to LED array 211 at nodes C, in order to turn ‘on’ the diodes. According to some embodiments such as depicted in FIG. 4, VLED 418 may be provided by DC regulator 430, which is powered by VDD 417.

In some embodiments of the present invention, such as depicted in FIG. 4, different values of Rₛₑₜ 440 may provide different ranges for I_{ref} 416. The specific values for I_{ref} 416 within each range may be set by DAC 410. In some embodiments of the present invention DAC 410 may generate I_{ref} 416 directly, rather than generating V_{ref} 415 and going through amplifier 405.

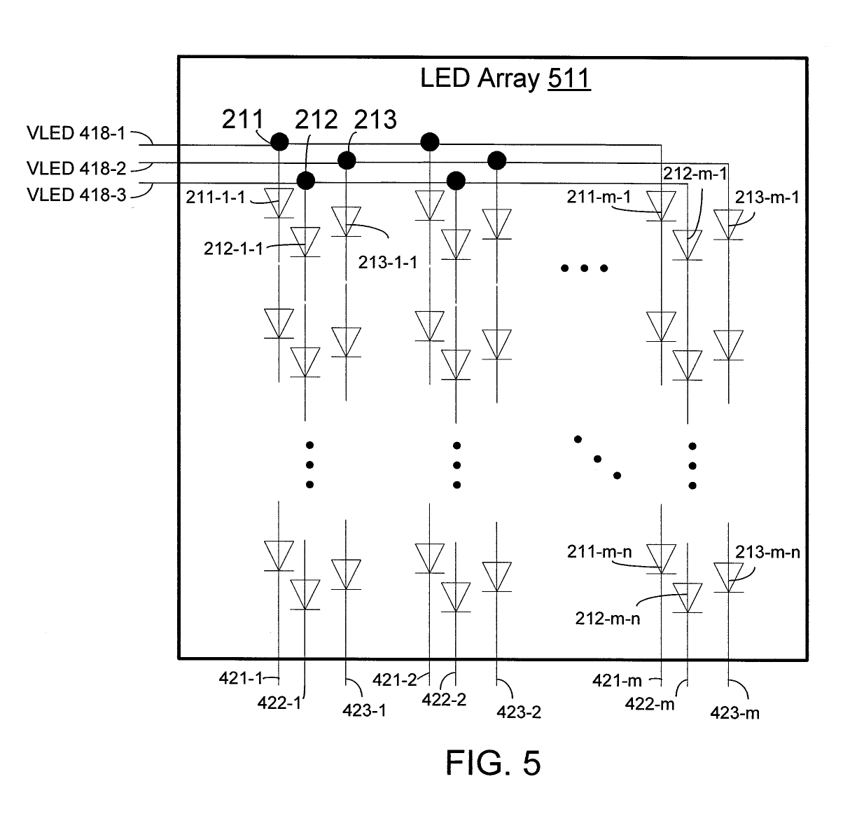

FIG. 5 shows LCD panel 110 according to some embodiments of the present invention using three co-located arrays of LEDs: 211, 212, and 213. LED arrays 211, 212, and 213 may have the same dimensions ‘m×n’. For example, each of the co-located LED arrays 211, 212 and 213 may have LEDs 211-1-1 to 211-m-n, 212-1-1 to 212-m-n, and 213-1-1 to 213-m-n, wherein LEDs 211-i-j are co-located with LEDs 212-i-j, and LEDs 213-i-j, with ‘i’, ‘j’ any integer between 1 and ‘m’ (‘i’), and 1 and ‘n’ (T). Furthermore, according to some embodiments of the present invention LEDs 211-i-j may emit light in a specific wavelength; LEDs 212-i-j may emit light in a specific wavelength different from that of LEDs 211-i j; and LEDs 213-i-j may emit light in a specific wavelength different from that of LEDs 211-i-j and LEDs 212-i-j. In the embodiment illustrated in FIG. 5, LED driver 245 (cf. FIG. 4) may provide three different sets of currents: 421-1 to 421-m to columns 1 to m in array 111; 422-1 to 422-m to columns 1 to m in array 112; 423-1 to 423-m to columns 1 to m in array 113. Further according to some embodiments such as illustrated in FIG. 5, LED driver 245 may provide voltages 418-1, 418-2, and 418-3 to each of LED arrays 211, 212, and 213, respectively. Voltages 418-1, 418-2, and 418-3 may enable each of LED arrays 211, 212, and 213 to be turned ‘on’ or ‘off’ according to the value provided.

Some embodiments of a display 205 including LED array 511 may have a number of LEDs in each array equal to the number of pixels in the display. Thus, each set of pixels 211-i-j, 212-i-j, and 213-i-j (where ‘i’ and ‘j’ are integers between 1 and ‘in’, ‘n’, respectively) may be part of an image pixel in display 205. Some embodiments using LED driver 245 as illustrated in FIG. 3, and LED array 511 illustrated in FIG. 5, may not use a liquid crystal layer or an array of transistors 301 such as illustrated in FIG. 3.

Embodiments of the invention described above are exemplary only. One skilled in the art may recognize various alternative embodiments from those specifically disclosed. Those alternative embodiments are also intended to be within the scope of this disclosure. As such, the invention is limited only by the following claims.

What is claimed is:

1. A liquid crystal display (LCD) panel system comprising:
a display system; and
a timing controller and power management circuit to provide control signals and power to the display system; wherein
the control signals comprise an adjustable current to control the LCD panel brightness.

2. The liquid crystal display (LCD) panel system wherein the control signals further comprise a pulse width modulation (PWM) signal.

3. The LCD panel system of claim 1 wherein the display system comprises:
an LCD panel having a backlight layer;
a backlight controller to provide control signals and power to the backlight layer;
a gate driver and a source driver to provide signals to the LCD panel.

4. The LCD panel system of claim 1 wherein:
the LCD panel comprises a light-emitting diode (LED) array; and
the backlight controller provides current to the LED array.

5. The LCD panel system of claim 4 wherein:
the timing controller and power management circuit provides a bit string to the backlight controller; and
the backlight controller provides current to the LED array using the bit string and a reference current.

6. The LCD panel system of claim 5 wherein the backlight controller comprises a digital-to-analog converter (DAC) circuit to provide the reference current from the bit string.

7. The LCD panel system of claim 5 wherein:
the backlight controller provides a reference voltage from the bit string; and the backlight controller comprises:
an amplifier circuit to provide a reference current from the reference voltage; and
a current mirror module to provide current to the LED array using the reference current.

8. The LCD panel system of claim 7 wherein the backlight controller comprises a DAC circuit to provide the reference voltage from the bit string.

9. A method for controlling the brightness of an LCD panel system having a display system comprising the steps of:
using a timing controller and power management circuit to provide control signals and power to the display system; the control signals comprising a PWM signal and an adjustable current to control the LCD panel brightness.

10. The method of claim 9 wherein the control signals further comprise a PWM signal.

11. The method of claim 9 wherein adjusting the amplitude of a current provided to the display system further comprises:
providing a bit string to a backlight controller;
converting the bit string to a current in the backlight controller; and
providing the current to an LED array in the display system.

12. The method of claim 11 wherein converting the bit string to a current in the backlight controller comprises:
using a DAC circuit to provide a reference current;
using the reference current to supply a current mirror module to provide a current to the LED array.

13. The method of claim 11 wherein converting the bit string to a current in the backlight controller comprises:
using a DAC circuit to provide a reference voltage;
using an amplifier circuit and the reference voltage to provide a reference current;
using the reference current to supply a current mirror module to provide a current to the LED array.
